(19) United States
(12) Patent Application Publication
(10) Pub. No.: US 2007/0299893 A1
(43) Pub. Date: Dec. 27, 2007

(54) Control apparatus

(75) Inventor: Mitsugu Matsuyama, Musashino-shi (JP)

Correspondence Address: EDWARDS ANGELL PALMER & DODGE LLP, P.O. BOX 55874, BOSTON, MA, 02205, US

(73) Assignee: Yokogawa Electric Corporation, Tokyo (JP)

(21) Appl. No.: 11/811,587

(22) Filed: Jun. 11, 2007

(30) Foreign Application Priority Data
Jun. 14, 2006 (JP) 2006-165224

(51) Int. Cl. G06F 15/00

(52) U.S. Cl. 708/200

(57) ABSTRACT

A control apparatus that communicates with a host apparatus, and includes: an input module; a control arithmetic section for performing an arithmetic process on an input signal obtained from the input module, and outputting a control signal; an output module in which an output value of the control signal from the control arithmetic section is written and held, and which supplies the output value to an external device connected to the output module; and an output value setting section for setting the output value of the output module to a predetermined value based on a command from the host apparatus, when the external device is not connected to the output module.

This application claims foreign priority based on Japanese Patent application No. 2006-165224, filed Jun. 14, 2006, the content of which is incorporated herein by reference in its entirety.

### BACKGROUND OF THE INVENTION

1. Field of the Invention

The present invention relates to a control apparatus that communicates with a host apparatus and includes: a control arithmetic section for performing an arithmetic process on an input signal obtained from an input module, and outputting a control signal; and an output module in which an output value of the control signal from the control arithmetic section is written and held, and which supplies the output value to an external device connected to the output module.

2. Description of the Related Art

Input/output module provided in a control apparatus in a distributed control system is disclosed in JP-A-2005-122592. FIG. 4 is a functional block diagram showing a structural example of a control apparatus having an output module of the related art.

In the distributed control system, a host apparatus 1 having a function of an operation monitoring apparatus is connected to a control bus 2. A control apparatus 3 is connected to the control bus 2 to communicate with the host apparatus 1. The control apparatus 3 includes a control arithmetic section 4 downloaded from the host apparatus and operating as a control application.

The control arithmetic section 4 includes an input section 41, an arithmetic section 42 and an output section 43. An input signal detected by an external device 6, such as a sensor, connected to an input module 5 is obtained by the arithmetic section 42 through the input section 41, and a control signal on which the arithmetic process is performed is sent to and written in an output module 7 as an output value through the output section 43.

The output module 7 reads the output value sent from the control arithmetic section 4 through a module interface 71, and writes the output value in an output holding section 73 through an output processing section 72 to hold the output value. The held output value is outputted to an external device 8 such as an operation end connected to an external device connecting interface

The external device connecting interface 74 has a function for detecting whether or not the external device 8 is connected to the output module 7 and supplying connection information M to the output processing section 72. The output processing section 72 supplies the connection information m to the output section 43 of the control arithmetic section 4 through the module interface 71.

The output section 43 writes the output value in the output module 7 when the external device 8 is connected to the output module 7, based on a status of the connection information m. When the external device 8 is not connected to the output module 7, the writing of the output value in the output module 7 is halted.

When a state of the external device 8 is changed from a state that the external device 8 is not connected to the output module 7 to a state that the external device 8 is connected to the output module 7, the output processing section 72 returns the output value held in the output value holding section 73 to the output section 43 of the control arithmetic section 4 through the module interface 71, based on the status of the connection information M. The output section 43 reads over the output value returned from the output module 7 to set the output value as the output value of the output section 43.

In such a way, between the control arithmetic section 4 and the output module, under an open state in which the external device is not connected to the output module, the writing of the output value is prohibited, and when the external device is connected to the output module, the output value held in the output module is read over so that a bump-less connection function is realized.

The function of the control apparatus of the related art has the following problems.

FIGS. 5A and 5B are image diagrams of what is called, a hot cut over, in which external devices operating in a plant is attached to another control apparatus under the operating state. FIG. 5A shows a state of the control apparatus immediately after the devices operating in the plant are separated from the control apparatus in order to carry out the hot cut over. FIG. 5B shows a state of the control apparatus on a stand-by side to which the separated devices are to be connected.

In this example, a control apparatus 3 in FIG. 5A has control arithmetic sections 4a and 4b. The control arithmetic section 4a inputs a detected value of an external device 6a such as a sensor through an input module 5a, and outputs 50% of the output value on which control arithmetic process is performed to an external device 8a such as an operation end through an output module 7a.

Similarly, the control arithmetic section 4b inputs a detected value of an external device 6b such as a sensor through an input module 5b, and outputs 80% of the output value on which control arithmetic process is performed to an external device 8b such as an operation end through an output module 7b.

On the stand-by side in FIG. 5B, components having the same functions as those of FIG. 5A are designated by the same reference numerals with “′”. Since external devices are not connected to an output module 7a′ and an output module 7b′, the output sections of control arithmetic sections 4a′ and 4b′ respectively halt the writing of the output values in the output modules 7a′ and 7b′ as described with reference to FIG. 4. Accordingly, the output values respectively held by the output modules are 0%.

In FIG. 5A, under a state immediately after all the external devices operating in the plant are separated from the control apparatus in order to carry out the hot cut over, the external device 8a such as the operation end holds 50% of the output value. Similarly, the external device 8b such as the operation end holds 80% of the output value.

FIGS. 6A and 6B are image diagrams showing states in which all the separated external devices under operation that are shown in FIG. 5A are attached to the corresponding input modules and output modules of the control apparatus on the stand-by side shown in FIG. 5B.

The external device 8a as the operation end holding 50% of the output value varies to 0% of the output value of the output module 7a′. Similarly, the external device 8b as the operation end holding 80% of the output value varies to 0% of the output value of the output module 7b′.

Then, based on connection information that the external devices are respectively connected to the output modules, 0% of the output values is read over to the control arithmetic sections respectively, so that the output values of the control arithmetic sections become 0%. Since 0% is written in each of the output modules, the output values of the output modules are respectively held to 0%.

Namely, in the basic function of a bump-less connection formed between the control arithmetic sections and the output modules in the control apparatus of the related art, when the hot cut over is carried out, a new problem arises that the output value of the external device as the operation end operating under a prescribed output value varies to 0%.

### SUMMARY OF THE INVENTION

The present invention has been made in view of the above circumstances, and provides a control apparatus capable of avoiding the output value of an external device operating with a prescribed output value from varying when a hot cut over is carried out.

In some implementations, a control apparatus of the invention that communicates with a host apparatus, the control apparatus comprising:

an input module;

a control arithmetic section for performing an arithmetic process on an input signal obtained from the input module, and outputting a control signal;

an output module in which an output value of the control signal from the control arithmetic section is written and held, and which supplies the output value to an external device connected to the output module; and

an output value setting section for setting the output value of the output module to a predetermined value based on a command from the host apparatus, when the external device is not connected to the output module.

In the control apparatus, when the control arithmetic section obtains information that the external device is not connected to the output module, the control arithmetic section halts the writing of the output value in the output module.

In the control apparatus, when the control arithmetic section obtains information that the external device is connected to the output module, the control arithmetic section reads over the output value set in the output module by the output value setting section to set the read output value as the output value of the control arithmetic section.

In the control apparatus, the output value setting section is provided in the output module.

In the control apparatus, the host apparatus is an operation monitoring apparatus in a distributed control system.

### BRIEF DESCRIPTION OF THE DRAWINGS

FIG. 1 is a functional block diagram showing a structural example of a control apparatus to which the present invention is applied.

FIGS. 2A and 2B are image diagrams of a hot cut over in which external devices operating in a plant is attached to a control apparatus on a stand-by side to which the present invention is applied, under a state that the external device is operating.

FIGS. 3A and 3B are image diagrams showing states in which all external devices are attached to the corresponding input modules and output modules of the control apparatus on the stand-by side to which the present invention is applied.

FIG. 4 is a functional block diagram showing a structural example of a control apparatus having an output module of the related art.

FIGS. 5A and 5B are image diagrams of a hot cut over in which external devices operating in a plant are attached to another control apparatus, under a state that the external device is operating.

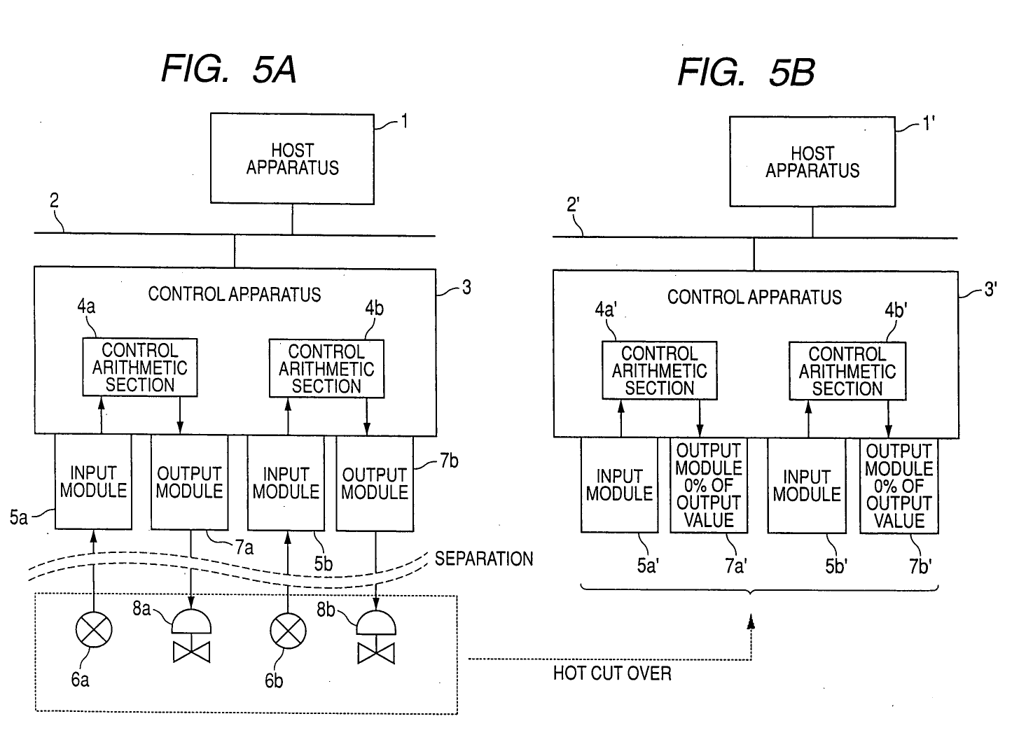

FIGS. 6A and 6B are image diagrams showing states in which all the external devices are attached to the corresponding input modules and output modules of the control apparatus on a stand-by side.

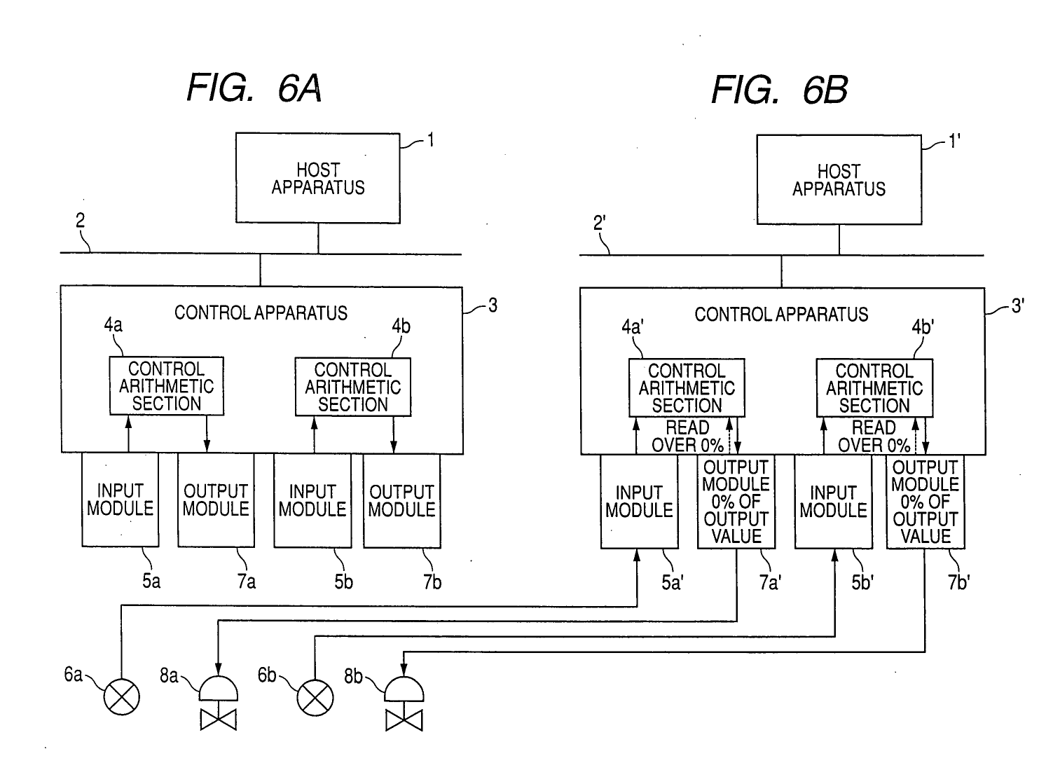

### DESCRIPTION OF THE PREFERRED EMBODIMENTS

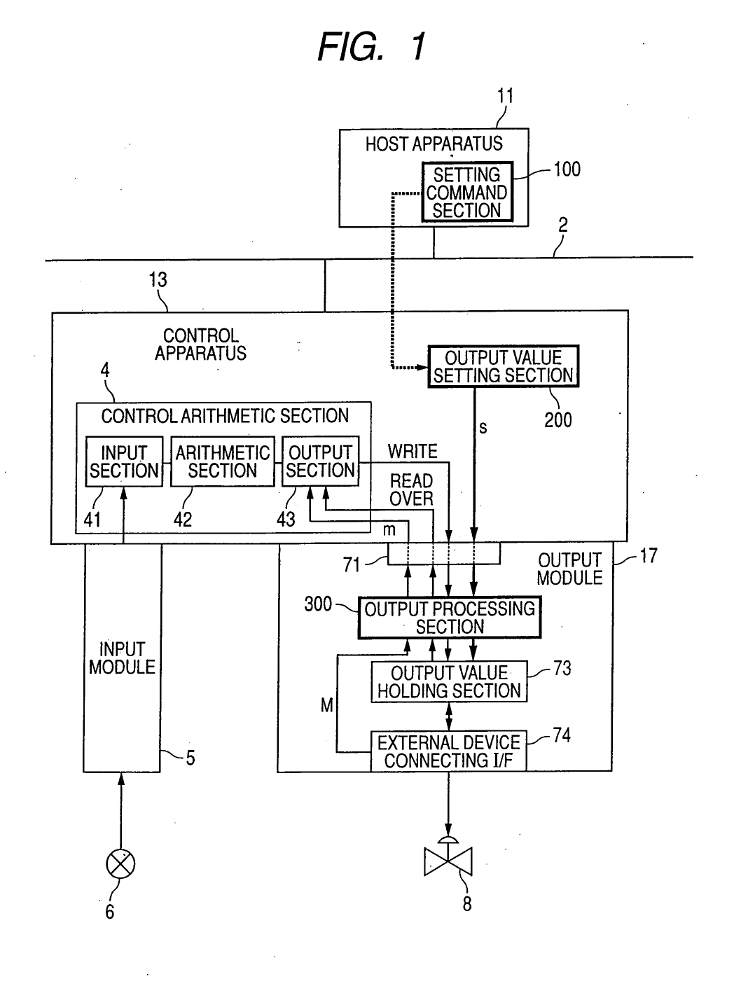

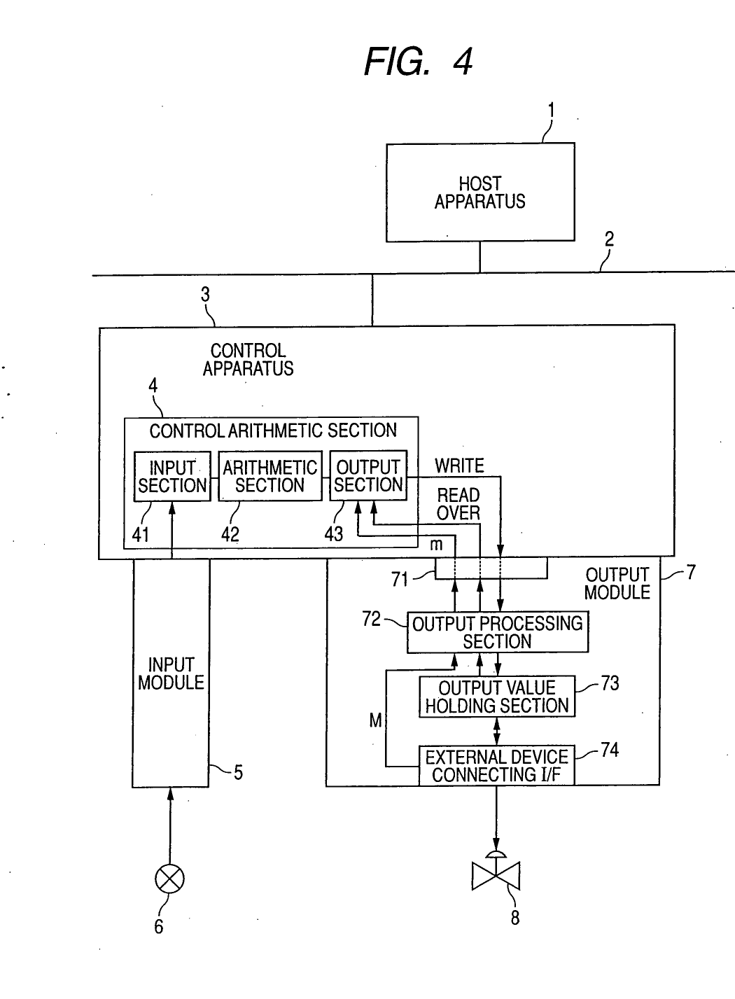

Now, an embodiment of the present invention will be described in detail by referring to the drawings. FIG. 1 is a functional block diagram showing a structural example of a control apparatus to which the present invention is applied. The same components as those of the control apparatus of the related art described with reference to FIG. 4 are designated by the same reference numerals and an explanation thereof is omitted.

In FIG. 1, a host apparatus 11 includes a setting command section 100 to download a setting command value by an operator to a control apparatus 13. In the control apparatus 13, an output value setting section 200 is provided, and obtains the setting command value from the setting command section 100.

A setting value S of the output value setting section 200 is supplied to an output processing section 300 of an output module 17 via a module interface 71. The output processing section 300 forcedly writes the obtained setting value S in an output value holding section 73 based on the status of the connection information M when an external device 8 is not connected to the output module 7, in addition to the basic function of the output processing section 72 of the related art described with reference to FIG. 4.

Upon performing the hot cut over, the operator checks the output value of the operating external device to be connected under a state that the external device is not connected to the output module of the control apparatus on the stand-by side. Then, the same output value can be downloaded to the output value setting section 200 from the setting command section 100, and the setting value S can be set in the output value holding section 73 through the output processing section 300.

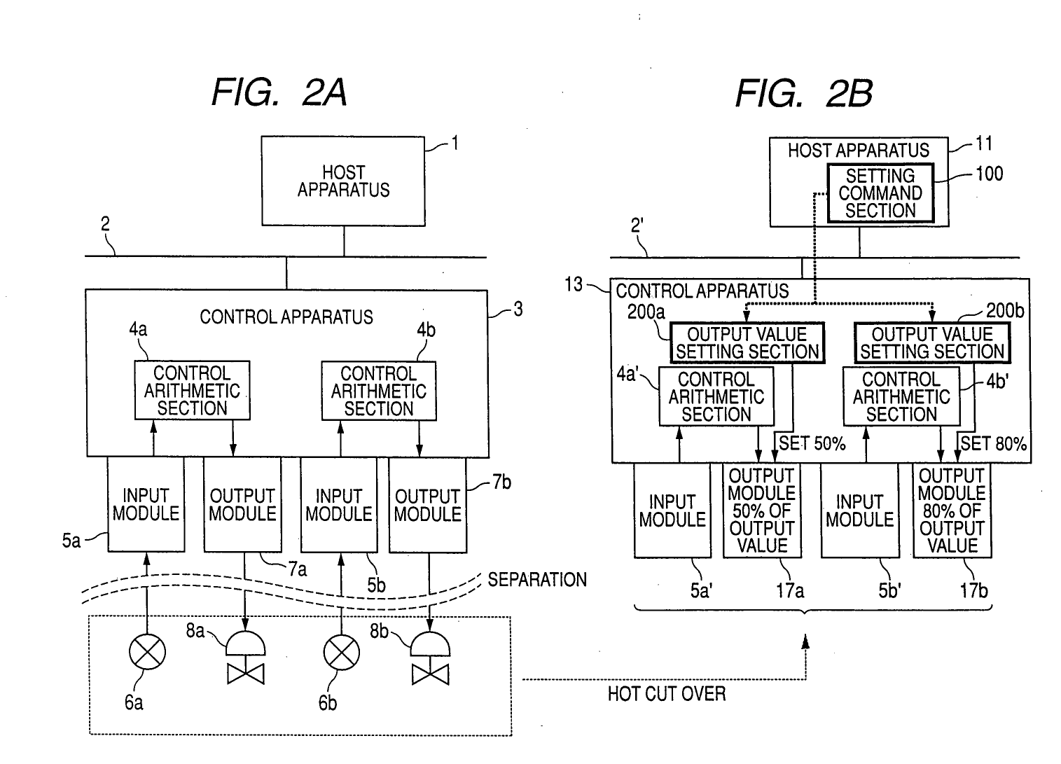

FIGS. 2A and 2B are image diagrams of the hot cut over in which external devices operating in a plant are attached to another control apparatus to which the present invention is applied, under a state that the external device is operating. FIG. 2A shows a state of the control apparatus immediately after the external devices operating in the plant are separated from the control apparatus in order to carry out the hot cut over. FIG. 2B shows a state of the control apparatus on the stand-by side to which the present invention is applied, to which the separated devices are to be connected.

In this embodiment, a control apparatus 3 of FIG. 2A has control arithmetic sections 4a and 4b. The control arithmetic section 4a inputs a detected value of an external device 6a such as a sensor through an input module 5a, and outputs 50% of the output value on which control arithmetic process is performed to an external device 8a such as an operation end through an output module 7a.

Similarly, the control arithmetic section 4b inputs a detected value of an external device 6b such as a sensor through an input module 5b, and outputs 80% of the output value on which control arithmetic process is performed to an external device 8b such as an operation end through an output module 7b.

On the stand-by side of FIG. 2B, components having the same functions as those of FIG. 2A are designated by the same reference numerals with “′”. In a control apparatus 13, output value setting sections 200a and 200b are provided, and 50% of the output value is set in an output module 17a and 80% of the output value is set in an output module 17b based on a command from a setting command section 100′ of a host apparatus 11.

In FIG. 2A, under a state immediately after all the external devices operating in the plant are separated from the control apparatus in order to carry out the hot cut over, the external device 8a such as the operation end holds 50% of the output value. Similarly, an external device 8b such as the operation end holds 80% of the output value.

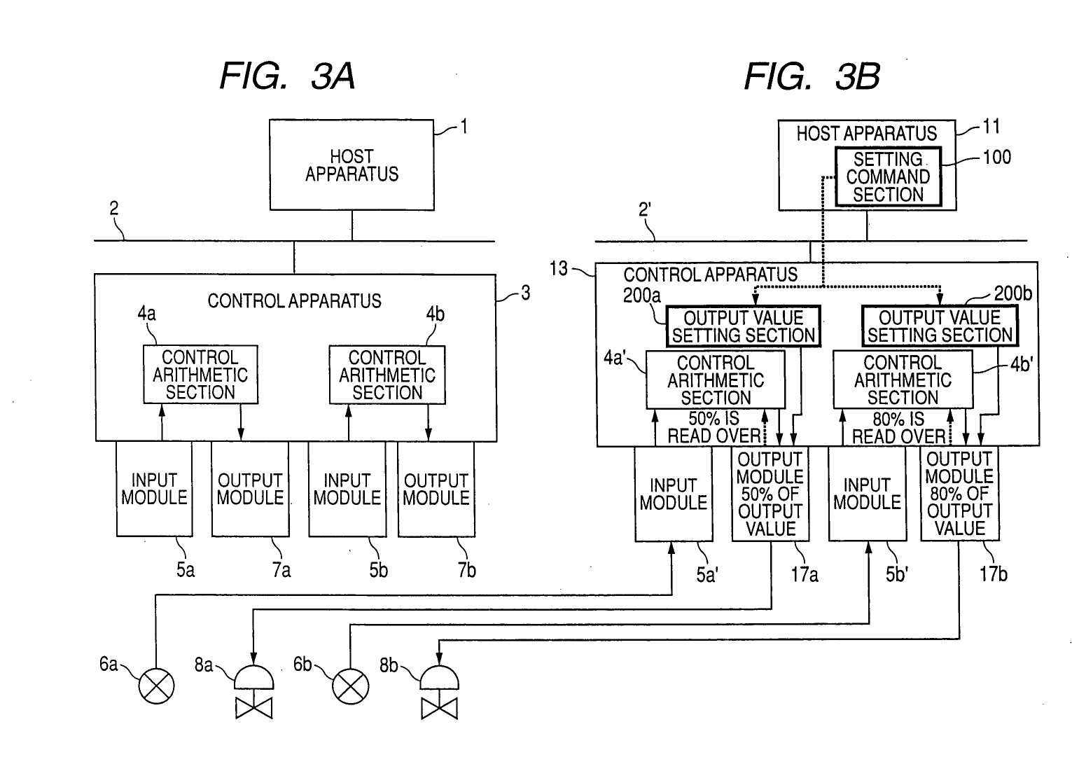

FIGS. 3A and 3B are image diagrams showing states in which all the separated external devices that are separated and shown in FIG. 2A are attached to the corresponding input modules and output modules of the control apparatus on the stand-by side in FIG. 2B to which the present invention is applied.

The external device 8a such as the operation end holding 50% of the output value corresponds to 50% of the output value previously set in the output module 17a so that a change does not occur. Similarly, an external device 8b such as an operation end holding 80% of the output value corresponds to 80% of the output value previously set in the output module 17b so that a change does not occur.

Then, based on the status of the connection information M about the external devices being respectively connected to the output modules, 50% and 80% of the output values are read over to the control arithmetic sections respectively, so that the output values of the control arithmetic sections become respectively 50% and 80%. Since 50% and 80% are written in each of the output modules, the output values of the output modules are respectively held to 50% and 80%.

Namely, according to an embodiment of the control apparatus to which the present invention is applied, upon performing the hot cut over without changing the basic function of a bump-less connection formed between the control arithmetic sections and the output modules in the control apparatus of the related art, a replacement can be completed without varying the output values of the external devices as the operation ends operating with the predetermined values.

Upon performing the hot cut over, the output value held in the corresponding output module can be previously forcedly set to the same output value in accordance with the output value of the external device operating with a predetermined output value. Thus, the change of the output value of the external device that occurs when the hot cut over is carried out can be avoided and a bump-less replacement environment can be realized.

In the above-described embodiment, an example is shown in which the output value setting section 200 is provided in the control apparatus 13, however, the output value setting section may be provided in each of the output modules as a standard function. Further, the host apparatus 11 may be an operation monitoring apparatus in a distributed control system.

It will be apparent to those skilled in the art that various modifications and changes can be made to the described preferred embodiments of the present invention without departing from the spirit or scope of the invention. Thus, it is intended that the present invention cover all modifications and changes of this invention consistent with the scope of the appended claims and their equivalents.

What is claimed is:

1. A control apparatus that communicates with a host apparatus, the control apparatus comprising:
an input module;
a control arithmetic section for performing an arithmetic process on an input signal obtained from the input module, and outputting a control signal;
an output module in which an output value of the control signal from the control arithmetic section is written and held, and which supplies the output value to an external device connected to the output module; and
an output value setting section for setting the output value of the output module to a predetermined value based on a command from the host apparatus, when the external device is not connected to the output module.

2. The control apparatus according to claim 1, wherein when the control arithmetic section obtains information that the external device is not connected to the output module, the control arithmetic section halts the writing of the output value in the output module.

3. The control apparatus according to claim 1, wherein when the control arithmetic section obtains information that the external device is connected to the output module, the control arithmetic section reads over the output value set in the output module by the output value setting section to set the read output value as the output value of the control arithmetic section.

4. The control apparatus according to claim 1, wherein the output value setting section is provided in the output module.

5. The control apparatus according to claim 1, wherein the host apparatus is an operation monitoring apparatus in a distributed control system.
